(19) United States
(12) Patent Application Publication
(10) Pub. No.: US 2020/0260703 A1
(43) Pub. Date: Aug. 20, 2020

(54) LURE WITH IMPROVED TAIL CONFIGURATION

(71) Applicant: SAVAGE GEAR AMERICAS, INC., Miramar, FL (US)

(72) Inventor: Mads Grosell, Copenhagen (DK)

(73) Assignee: SAVAGE GEAR AMERICAS, INC., Miramar, FL (US)

(21) Appl. No.: 16/276,008

(22) Filed: Feb. 14, 2019

(51) Int. Cl. A01K 85/16

(52) U.S. Cl. CPC A01K 85/16

(57) ABSTRACT

A fishing lure includes a head, a body coupled to the head, and a tail. The head, the body, and the tail define a longitudinal centerline. The tail includes a tail body having a first end coupled to the body and an opposing second end, and a tail fin coupled to the opposing second end of the tail body. The tail fin has a first sidewall and an opposing second sidewall that (i) extend vertically and laterally outward from the opposing second end of the tail body along a curved profile and (ii) terminate at a rear edge of the tail fin. Each of the first sidewall and the opposing second sidewall defines a notch that (i) extends (a) along the longitudinal centerline and (b) at least partially into the tail fin and (ii) separates the curved profile of the tail fin into an upper lobe and a lower lobe.

### TECHNICAL FIELD

The present application relates to fishing lures.

### BACKGROUND

Swimbait fishing lures are designed to attempt to mimic the swimming movement of a relatively smaller fish to attract larger game fish. While commercially available swimbait fishing lures may provide lateral tail oscillations in an attempt to mimic the swimming movement of a fish, such swimbait fishing lures do not have designs or features that reduce vertical movement of the tail and, therefore, do not accurately mimic the swimming movement of a real fish.

### SUMMARY

One embodiment relates to a fishing lure. The fishing lure includes a head portion, a main body coupled to the head portion, and a tail portion. The head portion, the main body, and the tail portion define a longitudinal centerline. The tail portion includes a tail body having a first end coupled to the main body and an opposing second end, and a tail fin coupled to the opposing second end of the tail body. The tail fin has a first sidewall and an opposing second sidewall that (i) extend vertically and laterally outward from the opposing second end of the tail body along a curved profile and (ii) terminate at a rear edge of the tail fin. Each of the first sidewall and the opposing second sidewall defines a notch that (i) extends (a) along the longitudinal centerline and (b) at least partially into the tail fin and (ii) separates the curved profile of the tail fin into an upper lobe and a lower lobe.

Another embodiment relates to a fishing lure. The fishing lure includes a head portion, a main body coupled to the head portion, and a tail portion. The tail portion includes a tail body and a tail fin. The tail body has a first end coupled to the main body and an opposing second end. The tail fin has a first sidewall and an opposing second sidewall that (i) extend from the opposing second end of the tail body and (ii) terminate at a rear edge of the tail fin. The tail body and the tail fin have a substantially pill-shaped cross-section.

Still another embodiment relates to a fishing lure. The fishing lure includes a head portion, a main body coupled to the head portion, and a tail portion. The tail portion includes a tail body and a tail fin. The tail body has a first end coupled to the main body and an opposing second end. The tail fin is coupled to the opposing second end of the tail body. The tail fin has a first sidewall defining a first cleavage and an opposing second sidewall defining a second cleavage. The tail fin has a substantially pill-shaped cross-section.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a front perspective view of a fishing lure having a body portion and a tail portion, according to an exemplary embodiment.

FIG. 2 is a rear perspective view of the fishing lure of FIG. 1.

FIG. 3 is a side view of the fishing lure of FIG. 1.

FIG. 4 is a top view of the fishing lure of FIG. 1.

FIG. 5 is a rear view of the fishing lure of FIG. 1.

FIG. 6 is a detailed view of the tail portion of the fishing lure of FIG. 1.

FIG. 7 is a first cross-sectional view of the tail portion of FIG. 1.

FIG. 8 is a second cross-sectional view of the tail portion of FIG. 1.

FIG. 9 is a third cross-sectional view of the tail portion of FIG. 1.

FIG. 10 is a side view of a fishing lure having a body portion and a tail portion, according to another exemplary embodiment.

FIG. 11 is a side view of a fishing lure having a body portion and a tail portion, according to still another exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a fishing lure (e.g., a swimbait fishing lure, a pulsing tail fishing lure, etc.) has a body portion and a tail portion. The body portion includes various anatomical features similar to a fish (e.g., a mouth, eyes, gill coverings, fins, scales, etc.). The tail portion includes a tail body and a rear fin (e.g., a tail fin, a caudal fin, etc.) coupled to an end of the tail body. The tail body has a substantially “pill-shaped” cross-sectional structure (e.g., similar to a rectangle with semi-circles on the ends, an obround, a stadium geometric shape, a capsule shape, etc.). The rear fin has a similar substantially pill-shaped cross-sectional structure and defines a cleavage (e.g., a tapered notch/channel, etc.) that extends inward into each lateral sidewall of the rear fin along a longitudinal centerline of the tail portion that separates the rear fin into an upper lobe and a lower lobe. According to an exemplary embodiment, (i) the pill-shaped structure of the tail body and rear fin and/or (ii) the cleavage of the rear fin facilitate fishing the fishing lure at both slow retrieval speeds and fast retrieval speeds while (a) maintaining a natural lateral swim action of the tail portion and (b) substantially eliminating any up and down movement of the tail portion of the fishing lure.

As used herein, the term “pill-shaped” refers to a shape that is similar to a rectangle with a semi-circle on each end thereof, which may more traditionally be referred to as an obround, racetrack, or stadium geometric shape.

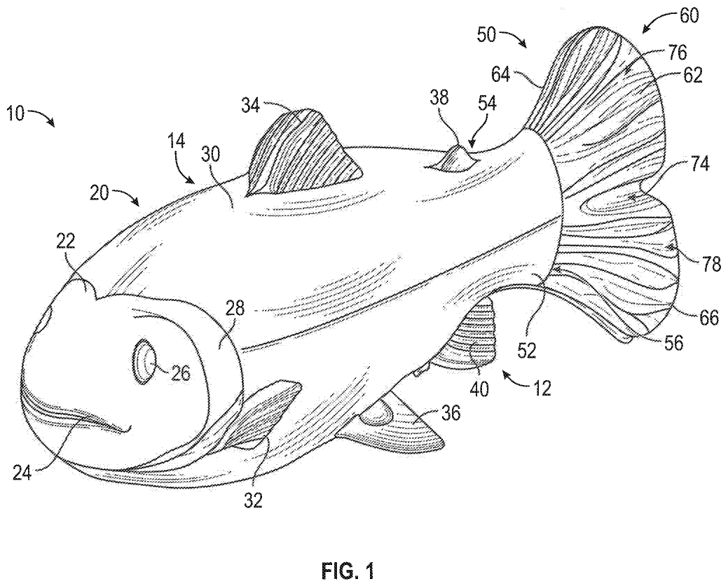

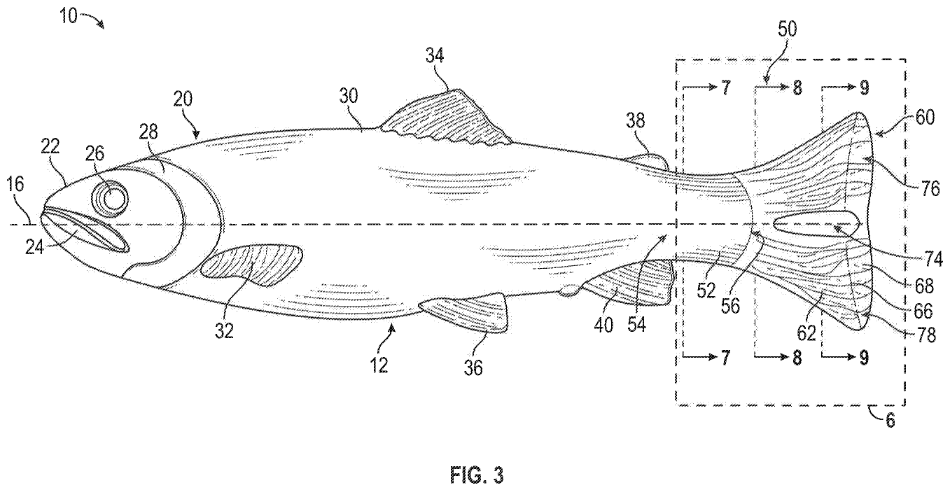

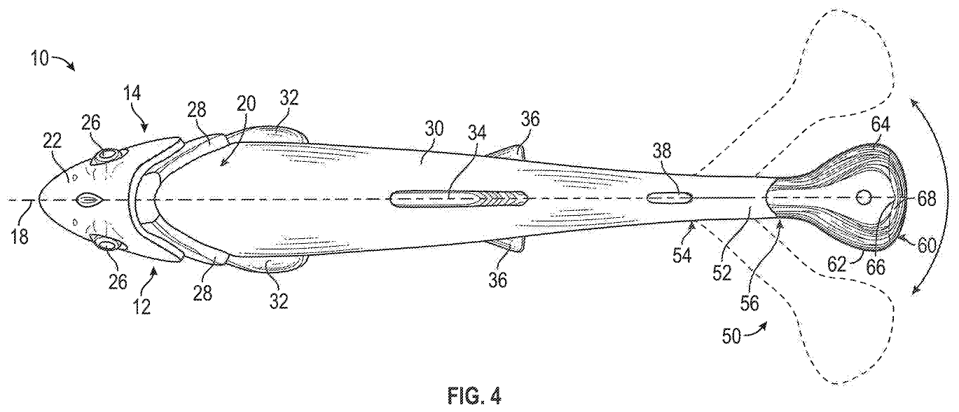

According to the exemplary embodiment shown in FIGS. 1-9, a fishing lure, shown as swimbait 10, is configured to provide a natural lateral swim action at both slow retrieval speeds and fast retrieval speeds. As shown in FIGS. 1-4, the swimbait 10 includes (i) a first portion, shown as body portion 20, having a head-like feature, shown as head 22, and a first body (e.g., an elongated body, etc.), shown as main body 30, and (ii) a second portion, shown as tail portion 50, having a second body, shown as tail body 52, coupled to the main body 30 and a rear fin (e.g., a tail fin, etc.), shown as caudal fin 60, coupled to the end of the tail body 52. As shown in FIG. 4, the tail portion 50 is configured to laterally oscillate back-and-forth relative to a plane, shown as vertical plane 18, that dissects the swimbait 10 in half between a first side, shown as left side 12, and an opposing second side, shown as right side 14, of the swimbait 10. The tail portion 50 is therefore configured to provide a natural lateral swim action.

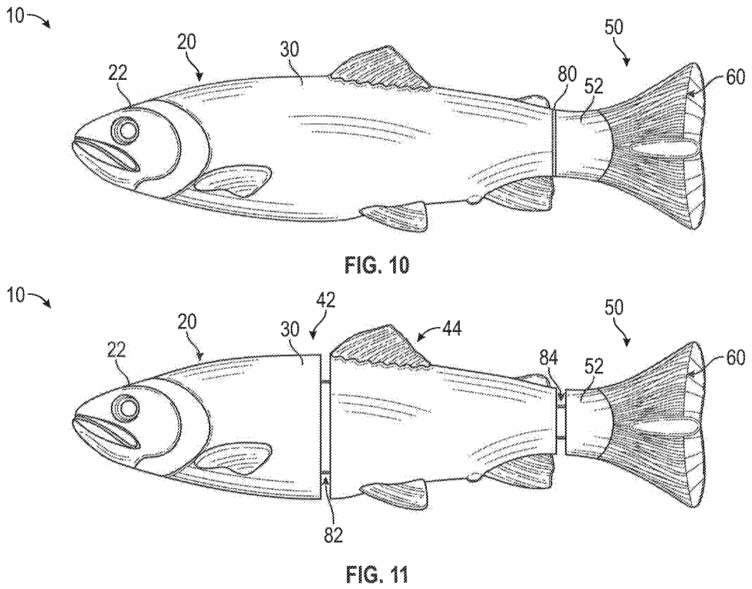

As shown in FIGS. 1-4, the body portion 20 and the tail portion 50 have a single, unitary structure. In some embodiments, the left side 12 of the swimbait 10 is manufactured independently of the right side 14 of the swimbait 10, which may thereafter be coupled together to form the swimbait 10. In such embodiments, the body portion 20 and the tail portion 50 may be manufactured from a soft, semi-soft, and/or semi-rigid flexible material. By way of example, the body portion 20 and/or the tail portion 50 may be manufactured from a rubber-like material, a thermoplastic elastomer (“TPE”), silicone, flexible polyvinyl chloride (“PVC”), semi-soft polyvinyl siloxane (“PVS”), and/or still other suitable soft, semi-soft, and/or semi-rigid flexible materials. In some embodiments, the body portion 20 is manufactured independently of the tail portion 50, which may thereafter be coupled together (see, e.g., FIGS. 10 and 11). In such embodiments, the body portion 20 and/or the tail portion 50 may be manufactured from a rigid material (see, e.g., FIG. 11). Alternatively, in such embodiments, the body portion 20 may be manufactured from a relatively more rigid material and the tail portion 50 may be manufactured from a relatively more flexible material (see, e.g., FIG. 10), or vice versa.

As shown in FIGS. 1-4, the head 22 and the main body 30 of the swimbait 10 include various features similar to the anatomy of a fish (e.g., a trout, a carp, a hitch, a ghost trout, etc.) such as a mouth 24, eyes 26, operculum or gill coverings 28, pectoral fins 32, a dorsal fin 34, pelvic fins 36, an adipose fin 38, and an anal fin 40. As shown in FIGS. 4 and 6, the body portion 20 and the tail portion 50 cooperatively define a longitudinal centerline of the swimbait 10, shown as anteroposterior axis 16, that extends from the center (i.e., midpoint) of the head 22, at the mouth 24 thereof (i.e., the anterior end of the swimbait 10), to the center and rear edge of the caudal fin 60 (i.e., the posterior end of the swimbait 10). The length of the anteroposterior axis 16 and, therefore, the swimbait 10 may vary between embodiments. By way of example, the length of the swimbait 10 may be selected based on the type of fish (e.g., bass, pike, musky, etc.) a fish angler is fishing for. In some embodiments, the length of the swimbait 10 ranges between two inches and twelve inches (e.g., six inches, eight inches, ten inches, etc.). In other embodiments, the length of the swimbait 10 is less than two inches (e.g., one inch, etc.) or greater than twelve inches (e.g., fourteen inches, etc.).

In some embodiments, the swimbait 10 includes a weight element disposed within the body portion 20 (e.g., within the head 22, within the main body 30, etc.). The weight element may be fixed within the body portion 20 or selectively removable and/or interchangeable (e.g., to facilitate tuning by an angler, etc.). The weight of the swimbait 10 may be chosen (e.g., by a manufacturer, by a fish angler, etc.) to provide a desirable sink rate of the swimbait 10 when cast into a body of water. By way of example, the swimbait 10 may have a weight that ranges from one ounce to sixteen ounces (e.g., 1.5 ounces, 1.75 ounces, 7 ounces, etc.). The swimbait 10 may also include one or more hook elements coupled to and/or embedded within the body portion 20.

As shown in FIGS. 1-4 and 6, the tail body 52 has a first end (e.g., a posterior end, etc.), shown as front end 54, and an opposing second end (e.g., an anterior end, etc.), shown as rear end 56. As shown in FIGS. 1-4, the front end 54 of the tail body 52 of the tail portion 50 is coupled to a rear end of the main body 30 such that the tail body 52 extends rearward of the main body 30. As shown in FIGS. 1-6, the tail body 52 has a narrow profile (e.g., vertically, laterally, etc. relative to the main body 30, the caudal fin 60, etc.).

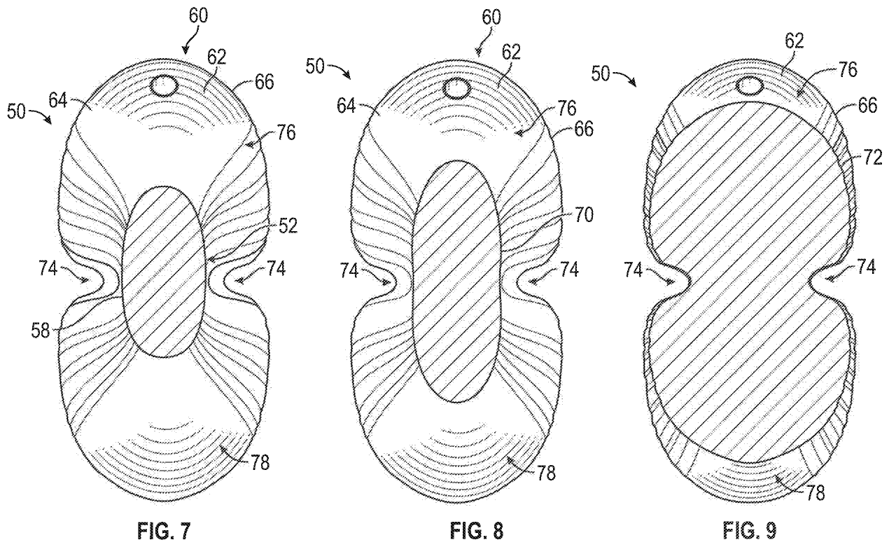

As shown in FIG. 7, the front end 54 of the tail body 52 has a first cross-section, shown as first cross-section 58, that extends with a substantially constant size and shape along the tail body 52, with minor variations due to a slight curvature of the tail body 52 (i.e., the rear end 56 of the tail body 52 has a substantially similar or the same cross-section as the first cross-section 58 of the front end 54 of the tail body 52). According to the exemplary embodiment shown in FIG. 7, the first cross-section 58 has a substantially pill-shaped structure. In other embodiments, the first cross-section 58 has another shape (e.g., ovular, diamond, hexagonal, etc.).

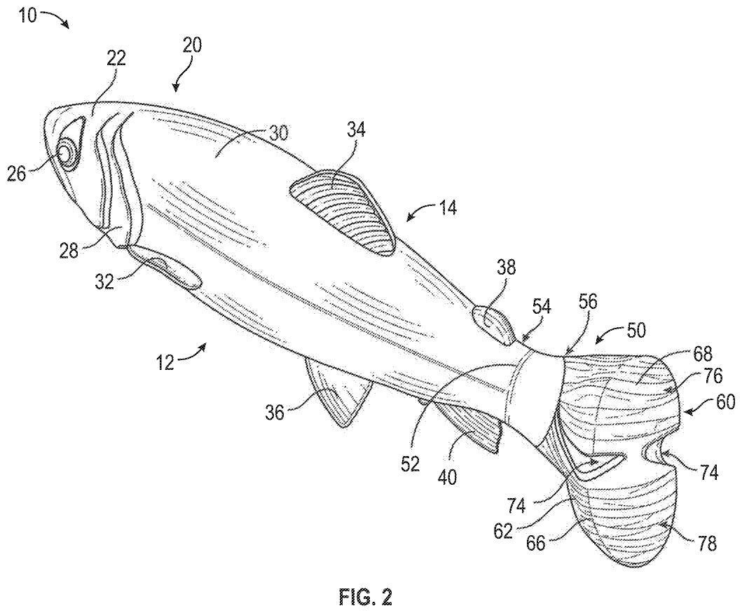

As shown in FIGS. 1-4 and 6, the caudal fin 60 is coupled to and extends from the rear end 56 of the tail body 52. As shown in FIGS. 1-4 and 6-9, the caudal fin 60 has a first sidewall, shown as left sidewall 62, and an opposing second sidewall, shown as right sidewall 64, that (i) extend laterally outward from the left side 12 and the right side 14 of the rear end 56 of the tail body 52, respectively, and (ii) extend vertically upward and downward from the rear end 56 of the tail body 52 to define a bulbous, curved profile that terminates at an edge, shown as rear edge 66, of the caudal fin 60. As shown in FIGS. 2-6, the rear edge 66 of the left sidewall 62 and the right sidewall 64 are connected by a wall, shown as rear wall 68. According to the exemplary embodiment shown in FIGS. 2-6, the rear wall 68 of the caudal fin 60 has a curved, rounded, or dome shaped profile that extends rearward of the rear edge 66. In another embodiment, the rear wall 68 of the caudal fin 60 has another shaped profile (e.g., a diamond shaped profile, a trapezoidal shaped profile, a triangular shaped profile, etc.) that extends rearward of the rear edge 66. In other embodiments, the rear wall 68 is at least partially recessed into the caudal fin 60 (i.e., the rear wall 68 extends forward of the rear edge 66 into the caudal fin 60, the rear wall 68 is concave). In such embodiments, the recessed rear wall 68 may have a dome shape profile, a diamond shaped profile, a trapezoidal shaped profile, a triangular shaped profile, and/or still another shaped profile.

As shown in FIG. 8, a leading end portion of the caudal fin 60 connected to the rear end 56 of the tail body 52 has a second cross-section, shown as second cross-section 70. According to the exemplary embodiment shown in FIG. 8, the second cross-section 70 has the substantially same shape as the first cross-section 58 (e.g., pill-shaped, etc.), but the dimensions thereof (e.g., height, width, etc.) are larger than that of the first cross-section 58. In other embodiments, the second cross-section 70, in addition to having larger dimensions than the first cross-section 58, has a different shape that the first cross-section 58.

As shown in FIG. 9, a middle portion of the caudal fin 60 has a third cross-section, shown as third cross-section 72. According to the exemplary embodiment shown in FIG. 9, the third cross-section 72 has the substantially same shape as the first cross-section 58 and the second cross-section 70 (e.g., pill-shaped, etc.), but the dimensions thereof (e.g., height, width, etc.) are larger than that of the first cross-section 58 and the second cross-section 70. In other embodiments, the third cross-section 72, in addition to having larger dimensions than the first cross-section 58 and the second cross-section 70, has a different shape that the first cross-section 58 and/or the second cross-section 70.

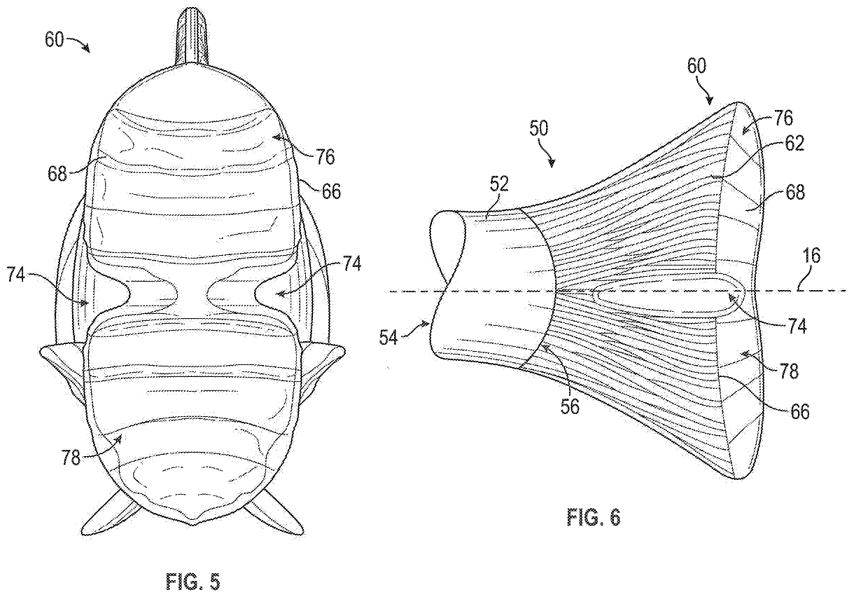

As shown in FIGS. 5 and 7-9, the rear edge 66 of the caudal fin 60 forms an outermost periphery of the caudal fin 60 that has the substantially same shape as the first cross-section 58, the second cross-section 70, and the third cross-section 72 (e.g., pill-shaped, etc.), but the dimensions thereof (e.g., height, width, etc.) are larger than that of the first cross-section 58, the second cross-section 70, and the third cross-section 72. Accordingly, the tail body 52 and the caudal fin 60 may have a cross-section that is generally consistent in-shape, but expands along a non-linear (i.e., curved) profile in the vertical and lateral directions from the rear end 56 of the tail body 52 to the rear edge 66 of the caudal fin 60 (e.g., to form the bulbous, curved profile). In an alternative embodiment, the cross-section of the of the tail portion 50 is generally consistent in-shape, but expands along a linear profile from the rear end 56 of the tail body 52 to the rear edge 66 of the caudal fin 60.

As shown in FIGS. 1-3 and 5-9, the left sidewall 62 and the right sidewall 64 of the caudal fin 60 each define a notch or channel, shown as a cleavage 74, that (i) extends (a) along the anteroposterior axis 16, (b) at least partially into the caudal fin 60 (e.g., to a depth that is in-line with the width of the narrow profile of the tail body 52, etc.), and (c) from the front of the bulbous, curved profile (e.g., proximate the rear end 56 of the tail body 52, etc.) through the rear wall 68 of the caudal fin 60 and (ii) separates the bulbous, curved profile of the caudal fin 60 into two lobes, shown as upper lobe 76 and lower lobe 78. In some embodiments, the left sidewall 62 and/or the right sidewall 64 define a plurality of the cleavages 74 (e.g., two, three, etc.).

As shown in FIGS. 5 and 7-9, the cleavages 74 have a tapered cross-sectional shape. According to the exemplary embodiment shown in FIGS. 5 and 7-9, the tapered cross-sectional shape is “U-shaped” or “V-shaped.” In other embodiments, the cleavages 74 have another cross-sectional shape. By way of example, the cleavages 74 may have a semi-circular, an ovular, a rectangular, etc. cross-sectional shape. In some embodiments, the cleavages 74 have a tapered or narrowing longitudinal shape. By way of example, the inlet of the cleavages 74 (i.e., the end proximate the front of the caudal fin 60) may be larger than the outlet of the cleavages 74 (i.e., the end proximate the rear of the caudal fin 60), or vice versa. By way of another example, a front portion of the cleavages 74 (e.g., a front half, etc.) may taper or narrow and the rear portion (e.g., a rear half, etc.) may expand such that the cleavages 74 have a “bow-tie” longitudinal shape or an “hour-glass” longitudinal shape.

According to an exemplary embodiment, (i) the pill-shaped cross-sectional profile of the tail body 52, (ii) the pill-shaped cross-sectional profile the caudal fin 60, and/or (iii) the cleavages 74 provide a swimbait fishing lure with (a) reduced vertical tail movement, (b) reduced drag, and (c) a natural, tight-kicking swim action within a wide range of retrieval speeds (e.g., at slow retrieval speeds less than 0.1 knots, at fast retrieval speeds in excess of 10 knots, at all speeds at which a fish angler would be expected to real in a lure while attempting to catch a fish, etc.). Specifically, the pill-shaped cross-sectional profile distributes water pressure equally to the top and bottom of the tail portion 50, which substantially inhibits vertical up and down movement of the tail portion 50, as well as facilitates a very natural lateral movement of the tail portion 50 at slow retrieval speeds. The cleavages 74 create a low pressure pass for water as the swimbait 10 moves through the water. Such a low pressure pass for the water reduces pressure applied to the tail portion 50 and facilitates retrieving the swimbait at an extremely fast retrieval speed without causing cavitation, which also reduces drag. Such reduction in drag greatly reduces fatigue on the angler fishing the swimbait 10. Further, the water passing through each of the cleavages 74 creates a low pressure point that acts like a rail, which stabilizes the tail portion 50 and enhances the swim action thereof (i.e., further preventing vertical up and down movement of the tail portion 50). Further, the tapering or narrowing shape of the cleavages 74 facilitates pressure being applied evenly to the upper lobe 76 and the lower lobe 78.

In some embodiments, the body portion 20 is manufactured independently of the tail portion 50, which may thereafter be coupled together. As shown in FIG. 10, the body portion 20 and the tail portion 50 are coupled together at an interface, shown as coupling 80. In one embodiment, the coupling 80 is or includes adhesive. In another embodiment, the coupling 80 is or includes a thermal welding joint or an ultrasonic welding joint. In other embodiments, the coupling 80 is still another suitable coupling that may be used to join the body portion 20 and the tail portion 50 while still permitting oscillations of the tail portion 50 relative to the body portion 20. According to the exemplary embodiment shown in FIG. 10, the body portion 20 is manufactured from a first material and the tail portion 50 is manufactured from a second material that is different than the first material. In some embodiments, the second material is relatively more flexible that than the first material. In some embodiments, the first material is a relatively more rigid material (e.g., metal, rigid plastics, rigid rubber, carbon fiber, acrylonitrile butadiene styrene (“ABS”), rigid PVC, etc.), and the second material is a relatively more flexible material (e.g., flexible rubber, flexible plastic, TPE, silicone, flexible PVC, semi-soft PVS, etc.).

As shown in FIG. 11, the main body 30 is separated into two portions, shown as first portion 42 and second portion 44. In other embodiments, the main body 30 has a unitary structure. As shown in FIG. 11, the first portion 42 of the main body 30 and the second portion 44 of the main body 30 are coupled together with a first flexible coupler, shown as first hinge 82, and the second portion 44 of the main body 30 and the tail body 52 of the tail portion 50 are coupled together with a second flexible coupler, shown as second hinge 84. According to an exemplary embodiment, the first hinge 82 and the second hinge 84 are configured to facilitate relative movement between (i) the first portion 42 and the second portion 44 and (ii) the second portion 44 and the tail portion 50, respectively. In some embodiments (e.g., embodiments where the main body 30 has a unitary structure, etc.), the swimbait 10 does not include the first hinge 82. In some embodiments, the swimbait 10 is separated into more than three portions such that the swimbait 10 includes more than two hinges. According to the exemplary embodiment shown in FIG. 11, the body portion 20 (e.g., the head 22, the main body 30, the first portion 42, the second portion 44, etc.) and the tail portion 50 are manufactured from a rigid material. The rigid material of the body portion 20 may be the same or different than the rigid material of the tail portion 50. In other embodiments, the body portion 20 and/or the tail portion 50 may be manufactured from a soft, flexible material and/or a semi-soft, flexible material.

It should be understood that in various embodiments, the body portion 20 and the tail portion 50 may be manufactured as a single component, as multiple components, from the same material, and/or from different materials. In one embodiment, the body portion 20 is manufactured from a rigid material and the tail portion 50 is manufactured from a rigid material. In another embodiment, the body portion 20 is manufactured from a rigid material and the tail portion 50 is manufactured from a soft, flexible material. In another embodiment, the body portion 20 is manufactured from a rigid material, and the tail portion 50 is manufactured from a semi-soft, flexible material. In still another embodiment, the body portion 20 is manufactured from a soft, flexible material, and the tail portion 50 is manufactured from a soft, flexible material. In yet another embodiment, the body portion 20 is manufactured from a soft, flexible material, and the tail portion 50 is manufactured from a semi-soft, flexible material. In another embodiment, the body portion 20 is manufactured from a soft, flexible material, and the tail portion 50 is manufactured from a rigid material. In still another embodiment, the body portion 20 is manufactured from a semi-soft, flexible material, and the tail portion 50 is manufactured from a semi-soft, flexible material. In yet another embodiment, the body portion 20 is manufactured from a semi-soft, flexible material, and the tail portion 50 is manufactured from a rigid material. In another embodiment, the body portion 20 is manufactured from a semi-soft, flexible material, and the tail portion 50 is manufactured from a soft, flexible material.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the swimbait 10 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A fishing lure comprising:
a head portion;
a main body coupled to the head portion; and
a tail portion, the head portion, the main body, and the tail portion defining a longitudinal centerline, the tail portion including:
a tail body having a first end coupled to the main body and an opposing second end; and
a tail fin coupled to the opposing second end of the tail body, the tail fin having a first sidewall and an opposing second sidewall that (i) extend vertically and laterally outward from the opposing second end of the tail body along a curved profile and (ii) terminate at a rear edge of the tail fin,
wherein each of the first sidewall and the opposing second sidewall defines a notch that (i) extends (a) along the longitudinal centerline and (b) at least partially into the tail fin and (ii) separates the curved profile of the tail fin into an upper lobe and a lower lobe.

2. The fishing lure of claim 1, wherein the notch has at least one of a tapered cross-sectional shape or a tapered longitudinal shape.

3. The fishing lure of claim 1, wherein the tail body has a substantially pill-shaped cross-section.

4. The fishing lure of claim 1, wherein the tail fin has a substantially pill-shaped cross-section.

5. The fishing lure of claim 1, wherein the tail fin has a rear wall that extends between the rear edge of the first sidewall and the opposing second sidewall, the rear wall having a profile that extends rearward of the rear edge of the tail fin.

6. The fishing lure of claim 5, wherein the profile of the rear wall is curved.

7. The fishing lure of claim 5, wherein the notch extends through the rear wall.

8. The fishing lure of claim 1, wherein the tail portion is configured to oscillate laterally relative to the main body in response to water pressure acting on the tail portion while the fishing lure moves through water.

9. The fishing lure of claim 8, wherein the head portion, the main body, and the tail portion are manufactured from a flexible material.

10. The fishing lure of claim 8, wherein the head portion, the main body, and the tail portion are manufactured from a rigid material.

11. The fishing lure of claim 10, further comprising a hinge element or flexible element positioned between the main body and the tail portion to facilitate relative movement between the main body and the tail portion.

12. The fishing lure of claim 8, wherein the main body is manufactured from a first material, and the tail portion is manufactured from a second material that is different than the first material.

13. The fishing lure of claim 12, wherein the second material is relatively more flexible that than the first material.

14. A fishing lure comprising:
a head portion;
a main body coupled to the head portion; and
a tail portion including:
a tail body having a first end coupled to the main body and an opposing second end; and
a tail fin having a first sidewall and an opposing second sidewall that (i) extend from the opposing second end of the tail body and (ii) terminate at a rear edge of the tail fin;
wherein the tail body and the tail fin have a substantially pill-shaped cross-section.

15. The fishing lure of claim 14, wherein each of the first sidewall and the opposing second sidewall defines a channel that (i) extends at least partially into the tail fin and (ii) separates the tail fin into an upper lobe and a lower lobe.

16. The fishing lure of claim 15, wherein the head portion, the main body, and the tail portion define a longitudinal centerline, and wherein the channel is positioned along the longitudinal centerline.

17. The fishing lure of claim 15, wherein the channel has a tapered shape.

18. A fishing lure comprising:
a head portion;
a main body coupled to the head portion; and
a tail portion including:
a tail body having a first end coupled to the main body and an opposing second end; and
a tail fin coupled to the opposing second end of the tail body, wherein the tail fin has a first sidewall defining a first cleavage and an opposing second sidewall defining a second cleavage, and wherein the tail fin has a substantially pill-shaped cross-section.

19. The fishing lure of claim 18, wherein the first cleavage and the second cleavage have a tapered shape.

20. The fishing lure of claim 19, wherein the head portion, the main body, and the tail portion define a longitudinal centerline, and wherein the first cleavage and the second cleavage are positioned along the longitudinal centerline.
